(19) United States
(12) Patent Application Publication
(10) Pub. No.: US 2006/0198035 A1
(43) Pub. Date: Sep. 7, 2006

(54) Optical system mount

(76) Inventor: Charles Howard Glatter, Bronx, NY (US)

Correspondence Address: SWANSON & BRATSCHUN L.L.C., 1745 SHEA CENTER DRIVE, SUITE 330, HIGHLANDS RANCH, CO, 80129, US

(21) Appl. No.: 11/366,847

(22) Filed: Mar. 1, 2006

Related U.S. Application Data
(60) Provisional application No. 60/657,641, filed on Mar. 2, 2005.

(51) Int. Cl. G02B 7/02

(52) U.S. Cl. 359/819

(57) ABSTRACT

An optical system mount including a first and second mounting block with each mounting block having attachment means for attaching a separate user supplied optical device. The attachment means associated with the respective mounting blocks each define an alignment axis. The optical system mount further includes adjustment means associated with one or both of the first and second mounting blocks to adjust the orientation of the first alignment axis with respect to the orientation of the second alignment axis. The optical system mount also includes a connection between the first mounting block and the second mounting block. Preferably the connection provides for adjustment of the distance between the first and second mounting block.

### RELATED APPLICATIONS

This application claims the benefit, under 35 U.S.C. § 119 of U.S. Provisional Patent Application Ser. No. 60/657,641, filed Mar. 2, 2005, entitled “Binocular Mount For Two Independent Telescopes.”

### TECHNICAL FIELD

The present invention is directed toward an optical system mount to support two separate independent optical devices for binocular use and more particularly toward an optical system mount providing for collimation and inter-pupillary distance adjustments for two attached optical devices.

### BACKGROUND OF THE INVENTION

Optical devices such as telescopes designed for astronomical use typically have a single objective lens or mirror which gathers and focuses light and a single ocular lens or eyepiece which magnifies the image produced by the objective for viewing by the observer. This traditional telescope configuration necessarily requires that an astronomer view through the telescope with one eye.

Single eye observing can be avoided with the use of binoculars having two objective lenses and two eyepieces. Binoculars are generally used in the daytime for terrestrial observations. Accordingly, most binoculars are relatively low powered wide field devices with limited light gathering capabilities. Astronomical telescopes typically differ from regular binoculars by having a relatively large objective lens or mirror and by having the capacity for operation at multiple higher optical magnifications through the use of interchangeable eyepieces of various focal lengths. In addition, certain telescopes designed for astronomical use are configured to filter incident light to allow for the specialized viewing of specific objects. For example, solar telescopes for viewing the sun in white light or for filtering out all light except the very narrow spectral range of hydrogen alpha emissions are readily available.

It is generally acknowledged that binocular viewing is more comfortable than monocular viewing with an astronomical telescope. Normal monocular use of an astronomical telescope requires that the observer either close one eye, cover an eye with a patch, or simply ignore anything viewed through one eye. Thus, monocular viewing can be tiring and difficult for beginners. In addition, most observers perceive a binocular rendered image as more aesthetically pleasing or more detailed. An astronomical telescope can be converted to binocular use by placing a binocular adaptor featuring a beam splitter in the optical path before the eyepiece. Beam splitter based binocular adaptors however, split the light from the objective lens or mirror between each of two eyepieces resulting in a measurable decrease in the brightness of an object viewed through such a system. In addition, binocular adaptors can be expensive and cause focusing issues which must be addressed by the insertion of additional optical elements into the optical path, potentially causing degradation of the image viewed by an observer.

Some of the problems associated with beam splitter based binocular adaptors can be addressed by viewing in binocular fashion through two substantially identical telescopes mounted substantially parallel so that the eye pieces of each instrument are appropriately placed for binocular viewing. Achieving and maintaining such a mounting configuration presents substantial technical challenges. In particular, critical alignment of the optical axis of each telescope is necessary to allow the images received by both eyes to be merged into one image by an observer's brain. In addition, the distance between each ocular must be adjustable or precisely set to assure that the pupil of each of the observer's eyes is centered on the appropriate optical path. Pupil centering is made more problematic because of the differing inter-pupillary distances of various observers.

The present invention is directed toward overcoming one or more of the problems discussed above.

### BRIEF DESCRIPTION OF THE DRAWINGS

FIG. 1 is a perspective view of an embodiment of the present invention featuring adjustment means including slot hinges.

FIG. 2 is an exploded view of the embodiment of FIG. 1.

FIG. 3 is a perspective view of an embodiment of the present invention featuring adjustment means including a pivot pin.

FIG. 4 is a perspective view of the present invention featuring dovetail guides.

FIG. 5 is a perspective view of the present invention supporting two separate optical devices for binocular use.

### SUMMARY OF THE INVENTION

One embodiment of the present invention is an optical system mount including a first and second mounting block with each mounting block having attachment means for attaching a separate user supplied optical device. The attachment means associated with the respective mounting blocks each define an alignment axis. The optical system mount further includes adjustment means associated with one or both of the first and second mounting blocks to adjust the orientation of the first alignment axis with respect to the orientation of the second alignment axis. The optical system mount also includes a connection between the first mounting block and the second mounting block.

When the optical system mount is in use, a pair of separate optical devices will be mounted to the mounting blocks and positioned appropriately for binocular viewing. Accordingly, in one embodiment of the present invention, the connection includes means for adjusting the distance between the first mounting block and the second mounting block, thus providing for an inter-pupillary distance adjustment. The adjustment connection may include a threaded member received in a threaded socket. The connection between the first and second mounting blocks may also include a guide associated with both the first mounting block and the second mounting block. The guide could be a shaft, dovetail or similar structure which adds stability to the system and preserves the alignment between the first and second mounting blocks as an inter-pupillary distance adjustment is made.

Various structures are suitable for implementation of the means for adjustment of the orientation of the first and second alignment axes. In one embodiment of the present invention, the adjustment means is implemented as one or more hinges associated with at least one of the mounting blocks. The hinge or hinges provide for the adjustment of the angular orientation of an alignment axis within one or more adjustment planes. In embodiments where the adjustment means include a hinge, one or more screws may also be included and operatively associated with the hinge allowing for the selective articulation of the hinge.

In one embodiment of the present invention, the adjustment means includes a first hinge operatively associated with the first mounting block which provides for adjustment of the first alignment axis within a first adjustment plane. A second hinge is similarly associated with the second mounting block which provides for adjustment of the second alignment axis within a second adjustment plane. The two adjustments planes may be, but are not required to be, orthogonal to each other.

In a preferred embodiment of the present invention, the first hinge is fabricated as a compliant hinge fabricated as a slot defined by the first mounting block and the second hinge is a compliant hinge fabricated as an orthogonal slot defined by the second mounting block. Although other hinge configurations are within the scope of the present invention, embodiments implemented with compliant or bending hinges such as slot hinges may be more structurally rigid and stable than embodiments with other types of hinges.

Another embodiment of the present invention is a method of mounting two separate optical devices. The method includes providing a system mount as described above and attaching a first optical device to the first mounting block and a second optical device to the second mounting block. The method also includes substantially aligning the optical axis of the first optical device with the optical axis of the second optical device by manipulating adjustment means operatively associated with at least one of the two mounting blocks. The method may also include adjusting the distance between the first optical axis and the second optical axis by adjusting the distance between the first mounting block and the second mounting block. Thus, practicing the method described herein allows a user to mount two separate optical devices, collimate the optical axes of the devices, adjust the inter-pupillary distance between the eyepieces of the devices and ultimately use the devices in binocular fashion.

### DETAILED DESCRIPTION OF THE INVENTION

The present invention includes several alternative embodiments of an optical system mount 10 and a method of mounting two separate optical devices using the optical system mount 10. In this description, like numbers will be used to identify like elements according to the different Figures which illustrate various embodiments of the invention. It should be noted, however, that specific construction details, including but not limited to the materials, shapes and numbers of certain elements may be varied from those shown in the figures and still remain within the scope of the claimed invention.

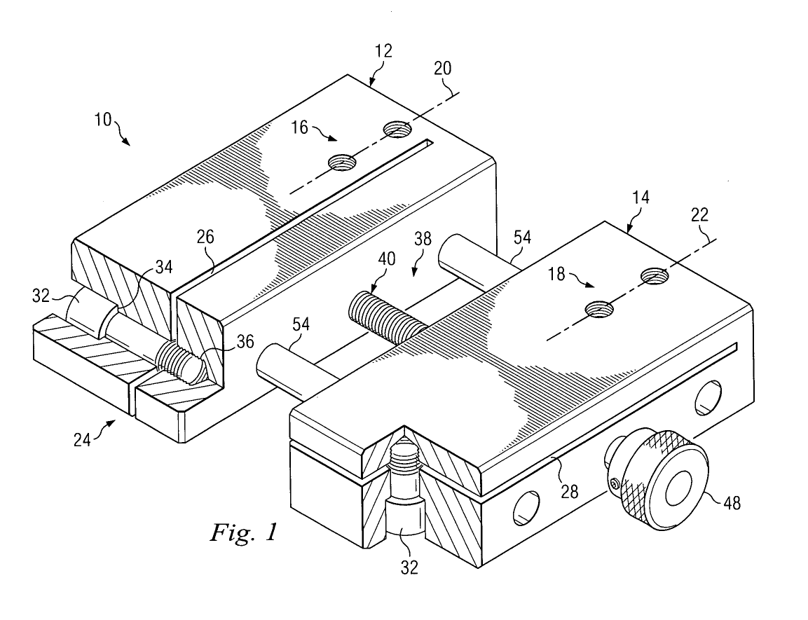

A preferred embodiment of the optical system mount 10 is shown in FIG. 1. The optical system mount 10 includes a first mounting block 12 and a second mounting block 14. In the embodiments of FIGS. 1-4, the first mounting block 12 and the second mounting block 14 are depicted as substantially rectangular block shaped structures. Other shapes however, including but not limited to, discs, plates, bars, open structures or irregular shapes can be selected for implementation of a first mounting block 12 or a second mounting block 14. The first mounting block 12 is associated with first attachment means 16. In the embodiment depicted in FIG. 1 the first attachment means 16 consists of a pair of holes each of which may be a simple hole or a threaded hole for receiving a mounting screw. Other numbers or configurations of mounting holes are within the scope of the present invention. The first attachment means 16 provides for the attachment of a separate optical device to the first mounting block. In the embodiment of FIG. 1, a separate optical device may be attached to the first mounting block 12 by passing one or more attachment bolts through the hole or holes of the first attachment means 16 into engagement with a threaded receptacle or other structure associated with the separate optical device. Although the first attachment means 16 is depicted as a pair of holes defined by the first mounting block 12 in FIGS. 1-4, other types of attachment means are within the scope of the present invention. In particular, a separate optical device might be attached to the first mounting block with a dovetail connection, mounting rings, permanent or semi-permanent adhesives, or other known clamping or attachment devices or methods commonly used in the mechanical arts. Any structure may be used to implement the first attachment means 16 provided the structure is suitable for rigidly attaching a separate optical device to the first mounting block 12. A second attachment means 18 which is similar in all respects to the first attachment means 16 is associated with the second mounting block 14.

As shown in FIG. 1, the first attachment means 16 defines a first alignment axis 20. Similarly, the second attachment means defines a second alignment axis 22. In the embodiments of FIGS. 1-4 an axis connecting the center point of the two holes of the first attachment means 16 or second attachment means 18 defines the first and second alignment axes 20, 22. Alternatively, the first and second alignment axis 20, 22 can be defined by another structure, including but not limited to a surface of the first and second mounting block 12, 14. The present invention is not limited to this configuration. For example, an alignment axis may be defined by a structure such as a dovetail connection, or the center points of one or more mounting rings. Alternatively, the alignment axis may be arbitrarily defined with respect to the first or second attachment means 16, 18, respectively. In all instances, the alignment axis is substantially parallel to the optical axis of any optical device which will ultimately be attached to the first mounting block 12 or the second mounting block 14.

The preferred embodiment of the present invention also includes adjustment means 24 associated with at least one of the first mounting block 12 and the second mounting block 14. The adjustment means 24 provides for the adjustment of the orientation of the first alignment axis 20 with respect to the orientation of the second alignment axis 22. The adjustment means may be implemented with any apparatus which allows for adjustment of the orientation of the first alignment axis 20 with respect to the second alignment axis 22. For example, the adjustment means 24 may include pivots, bearings, slides, hinges, moveable connections, bendable members or other positionable apparatus.

In the embodiment depicted in FIGS. 1-4, the adjustment means includes a first hinge 26 associated with the first mounting block 12 and a second hinge 28 associated with the second mounting block 14. The first hinge has a vertical pivot which provides adjustment of the orientation of first alignment axis 20 within a substantially horizontal plane. The second hinge 28 has a horizontal pivot which provides for vertical adjustment of the orientation of the second alignment axis 22. Thus, the adjustment means 24 may be used to adjust the orientation of the first alignment axis 20 with respect to the second alignment axis 22 in two dimensions, and ultimately collimate the two separate optical devices which may be mounted to the first and second mounting blocks 12, 14, respectively.

It is important to note that the structural implementation of the adjustment means 24 depicted in FIG. 1 is only one possible implementation of the adjustment means 24. Variations on the implementation include, but are not limited to, embodiments where the first and second hinges 26, 28 are both formed in one mounting block or where the first and second hinges operate with pivots that are not positioned in orthogonal vertical and horizontal planes. Aligning the optical axis of separate optical devices mounted to the optical system mount 10 may be facilitated, however, if the adjustment means 24 provides for adjustments within two orthogonal planes as is shown in the FIG. 1.

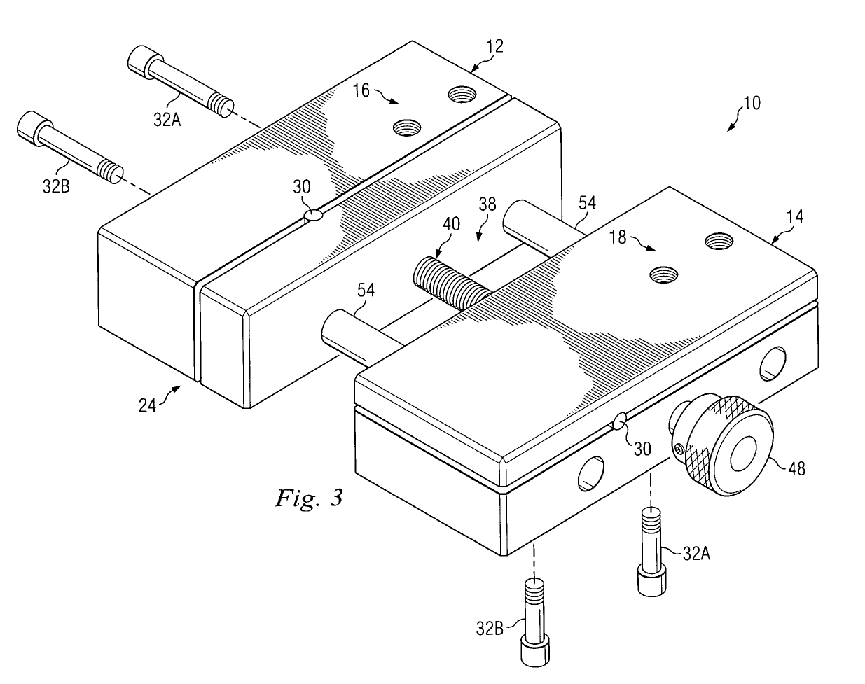

In any embodiment of the adjustment means 24 which features one or more hinges as a component, the hinges may be fabricated by any means known in the mechanical arts. For example, FIG. 1 shows first and second hinges 26, 28 which are slots machined into the first and second mounting blocks 12, 14 which have no separate moving parts. This type of machined slot hinge which is one type of compliant hinge known in the mechanical arts is preferred because it is substantially rigid and very little incidental movement other than the desired movement at the pivot of the hinge is allowed. This type of hinge enhances the ability of the optical system mount 10 to rigidly support separate optical devices and maintain proper optical collimation. A variation of the first and second hinge 26, 28 is depicted in FIG. 3 where the hinge includes a centrally disposed pivot pin 30. The embodiment shown in FIG. 3 provides for a greater range of adjustment motion. Other hinge types, including conventional hinges disposed between portions of a given mounting block are also suitable for the implementation of the present invention.

The adjustment means 24 may also include one or more screws 32 operatively associated with at least one of the first hinge 26 and the second hinge 28. A screw 32 may used to selectively articulate the hinge. In the preferred embodiment of FIG. 1, the screw 32 shown in phantom lines fits within a recessed socket associated with one side of the first mounting block 12, extends transverse the open end of the first hinge 26 and is received in a threaded socket 36 machined into the other side of the first mounting block 12. Thus, rotation of the screw 32 may be used to selectively articulate the first hinge 26 causing adjustment of the first alignment axis 20. Alternatively, screw 32 may be received in a threaded socket 36 on the same side of the first mounting block 12 and operate by pushing against the mounting block transverse the open end of the first hinge 26. Although screw 32 is shown as a hex socket head screw in FIG. 1, screw 32 may alternatively be implemented with any threaded device including a standard machine bolt, machine screw or threaded rod with or without a separate actuation head. As is shown in FIG. 1, a similar screw 32 may be associated with the second hinge 28.

More than one screw 32 may be associated with the adjustment means 24. For example, the embodiment of FIG. 3 features two screws 32A and 32B associated with each hinge. The two screws 32A and 32B thread into the mounting block on either side of the pivot pin 30 and provide for a coordinated push or pull configuration for adjustment of the hinge within its range of motion and additionally provide for the ability to clamp the hinge into a locked position after adjustments have been made.

The optical system mount 10 also includes a connection 38 between the first mounting block 12 and the second mounting block 14. The connection 38 holds the first mounting block 12 adjacent to the second mounting block 14 in an operative configuration. Preferably the connection 38 provides a mean for adjusting the distance between the first mounting block 12 and the second mounting block 14. An adjustable connection thus provides a method for adjusting the inter-pupillary distance between the eyepieces of two separate optical devices one of which will be mounted to each mounting block.

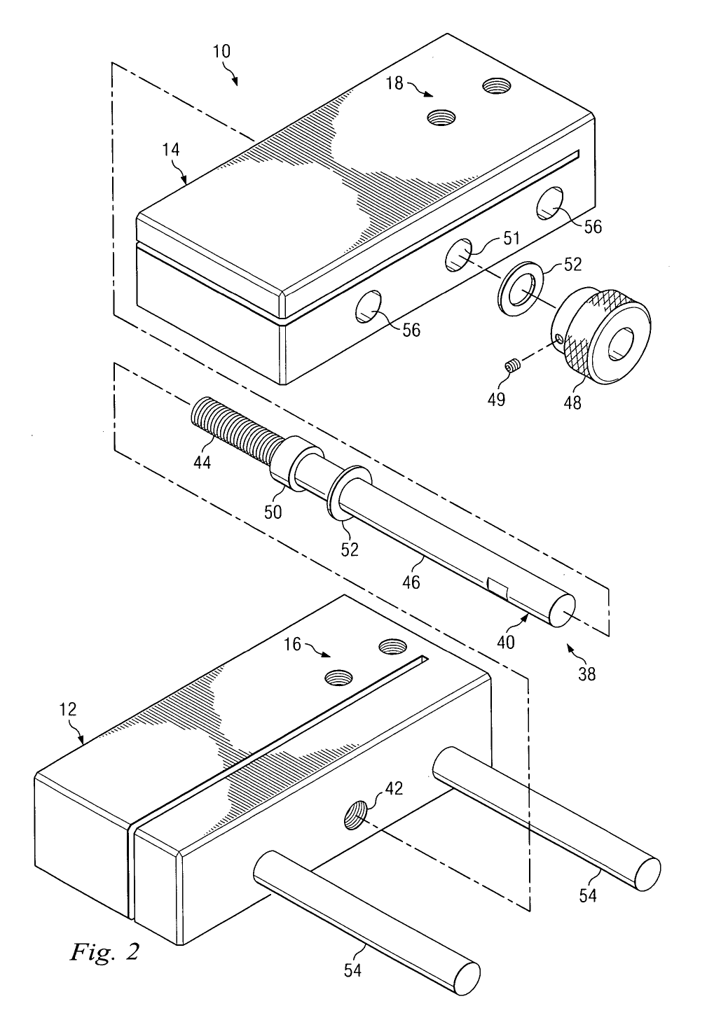

As is best seen in the exploded view of FIG. 2, a connection 38 featuring means for adjusting the distance between the first and second mounting blocks 12, 14 may be implemented with a threaded member 40 received in a threaded socket 42. The threaded socket 42 may be associated with either mounting block 12, 14 but is shown associated with the first mounting block 12 in FIG. 2. The threaded member 40 includes a threaded portion 44 opposite a shaft 46. The mounting block 14 not having the threaded socket 42 (the second mounting block 14 in FIG. 2) may be bored to receive the shaft 46. The shaft is operatively secured in place with a knob 48 and set screw 49. In this configuration, the second mounting block 14 is substantially secured from lateral movement with respect to the threaded member by shoulder 50 and knob 48. The shaft 46 is free however to rotate within the bore 51. One or more suitable washers 52 or other bearing surfaces may be used as bearings to reduce friction and assure a secure fit between the shaft 46 and the second mounting block 14 which is still free to rotate. When the threaded portion 44 of the threaded member 40 is engaged with the threaded socket 42, the threaded member may be selectively rotated to drive the second mounting block 14 toward or away from the first mounting block 12 thus adjusting the distance between the blocks.

An adjustable connection 38 may be implemented with apparatus other than the threaded member 40. For example, the connection 38 may include one or more shafts which slide through sockets and are clamped with set screws or by other means. An adjustable connection could alternatively be implemented with a rack and pinion hinged members, a bellows device, a pneumatic or hydraulically actuated cylinder or other means known in the mechanical arts for adjusting the linear distance between two objects.

In embodiments where a threaded member 40 is used as the adjustable connection 38 it is not necessary that the threaded member feature a separate knob 48, a collar 50 or washers 52. The threaded member can be as simple as a machine screw or bolt.

It is desirable that the orientation of the first alignment axis 20 with respect to the second alignment axis 22 be maintained as the adjustable connection 38 is manipulated. Accordingly, a preferred embodiment of the connection 38 of the optical system mount 10 will include one or more guides 54 associated with both the first and second mounting blocks 12, 14. The guides serve to substantially preserve the orientation of the first and second alignment axes, 20, 22 by limiting the potential for tip or tilt movement between the first and second mounting blocks 12, 14 as the adjustable connection 38 is articulated. In the embodiment of FIGS. 1-3 the guides 54 are cylindrical pins which are attached to one of the mounting blocks and received in holes associated with the other mounting block. In the embodiment shown in the exploded view of FIG. 2, the guides 54 are captive in the first mounting block 12 and slide freely in the holes 56 of the second mounting block 14.

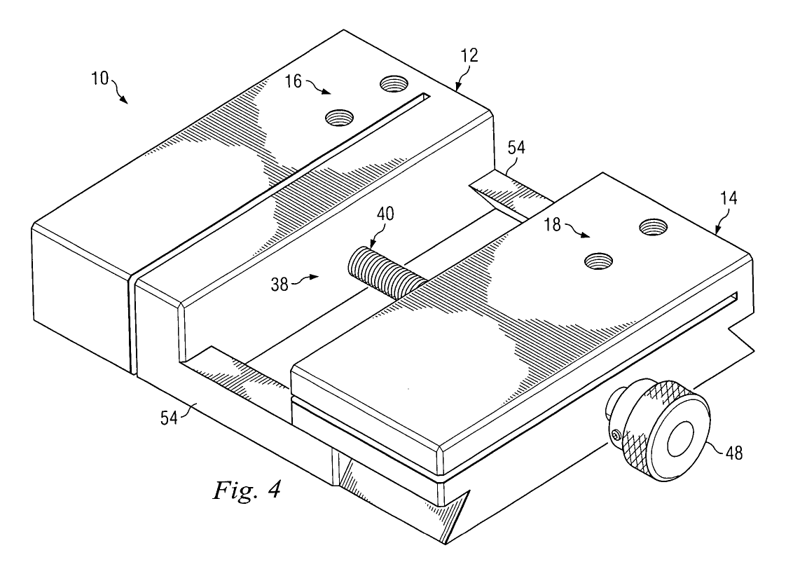

As is shown in FIG. 4, the guides may be implemented with any suitable structure which serves to limit tip or tilt movement between the two mounting blocks as they are adjusted with the adjustable connection 38. For example, the guides 54 may be implemented as mating prismatic structures of any suitable shape. Alternatively, the guides 54 could be implemented with linear roller bearings lubricated slides or similar structures.

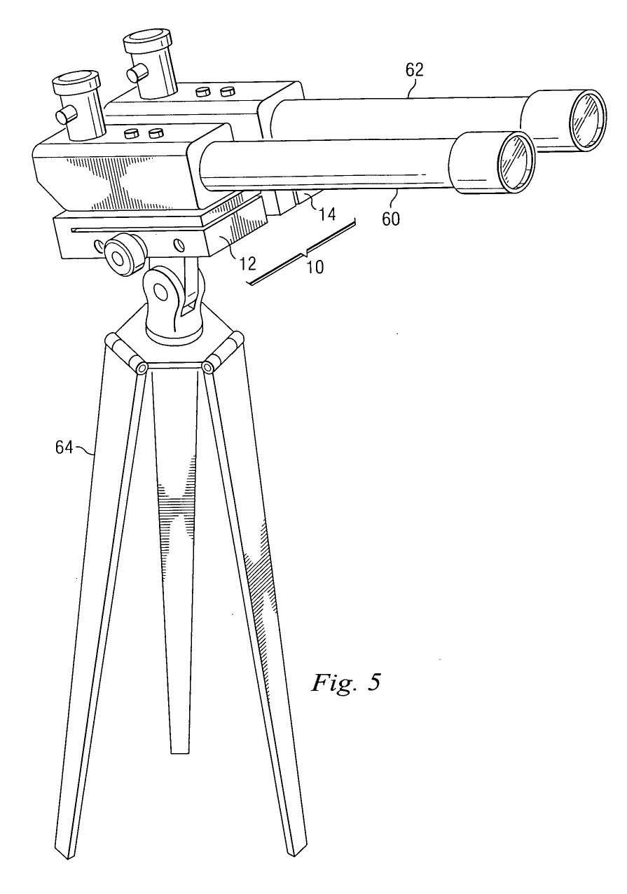

As shown in FIG. 5, the optical system mount 10 as described above may be used by attaching a first optical device 60 to the first mounting block 12 with the first attachment means 16. Similarly, a second separate optical device 62 may be attached to the second mounting block 14 with the second attachment means 18. Upon attachment, the optical axis of the first optical device 60 and the optical axis of the second optical device 62 may be brought into substantially collimated alignment by manipulating the adjustment means 24. In the embodiment of the optical system mount 10 depicted in FIG. 1, the collimation adjustment may be accomplished by selectively rotating the screw 32 associated with the first mounting block 12 to adjust the first alignment axis 20 and corresponding optical axis in a horizontal plane. Similarly, the screw 32 associated with the second mounting block 14 may be selectively rotated to adjust the second alignment axis 22 and associated optical axis in a vertical plane. The combined adjustments thus provide for collimation of the optical axes of the first and second optical devices 60, 62. The degree of collimation of the optical axes of the first and second optical devices 60, 62 may be confirmed usually by observing through each optical device, or by other suitable means.

In addition, the distance between the first optical axis and the second optical axis may be adjusted by selectively rotating the threaded member 40 or otherwise adjusting the connection 38 between the mounting blocks. Thus the optical system mount 10 as described herein supports the use of two separate optical devices in a binocular fashion.

As shown in FIG. 5, the optical system mount 10 may be attached to a tripod 64. Alternatively the optical system mount 10 may be hand held in use.

The optical system mount 10 has been described above as a separate mount or base which allows the attachment of a first optical device 60 and a separate optical device 62. In an alternative family of embodiments, the optical system mount 10 may include integrated first and second optical devices. In any embodiment featuring integrated first and second optical devices, the various collimation and interpupillary adjustment apparatus would be included and operated as described above.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

What is claimed is:

1. An optical system mount comprising:
a first mounting block having first attachment means defining a first alignment axis;
a second mounting block having second attachment means defining a second alignment axis;
adjustment means operatively associated with at least one of the first and second mounting blocks to adjust the orientation of the first alignment axis with respect to the orientation of the second alignment axis; and
a connection between the first mounting block and second mounting block.

2. The optical system mount of claim 1 wherein the connection further comprises means for adjusting a distance between the first mounting block and the second mounting block.

3. The optical system mount of claim 2 wherein the means for adjusting the distance between the first mounting block and the second mounting block comprises a threaded member received in a threaded socket.

4. The optical system mount of claim 2 wherein the connection comprises at least one guide operatively associated with both first mounting block and the second mounting block.

5. The optical system mount of claim 1 wherein the adjustment means comprises a hinge operatively associated with at least one of the first mounting block and the second mounting block.

6. The optical system mount of claim 5 wherein the adjustment means further comprises a screw operatively associated with the hinge to selectively articulate the hinge.

7. The optical system mount of claim 5 wherein the hinge comprises a slot defined by at least one of the first mounting block and the second mounting block.

8. The optical system mount of claim 1 wherein the adjustment means comprises:
a first hinge operatively associated with the first mounting block which provides for adjustment of the first alignment axis in a first adjustment plane; and
a second hinge operatively associated with the second mounting block which provides for adjustment of the second alignment axis in a second adjustment plane.

9. The optical system mount of claim 8 wherein the connection further comprises means for adjusting a distance between the first mounting block and the second mounting block.

10. The optical system mount of claim 8 wherein the first hinge comprises a slot defined by the first mounting block and the second hinge comprises a slot defined by the second mounting block.

11. An optical system mount comprising:
a first mounting block having first attachment means for attaching a first separate optical device;
a second mounting block having second attachment means for attaching a second separate optical device; and
an adjustable connection between the first and second mounting block for adjusting a distance between the first mounting block and the second mounting block.

12. The optical system mount of claim 11 wherein the adjustable connection comprises a threaded member received in a threaded socket.

13. The optical system mount of claim 11 wherein the adjustable connection comprises at least one guide operatively associated with both the first mounting block and the second mounting block.

14. The optical system mount of claim 11 further comprising:
a first alignment axis defined by the first attachment means which is substantially parallel to an optical axis of the first separate optical device;
a second alignment axis defined by the second attachment means which is substantially parallel to an optical axis of the second separate optical device; and
adjustment means operatively associated with at least one of the first mounting block and the second mounting block to adjust the orientation of the first alignment axis with respect to the second alignment axis.

15. A method of mounting two separate optical devices comprising:
providing a system mount comprising a first mounting block connected to a second mounting block wherein adjustment means are operatively associated with at least one of the first and second mounting blocks;
attaching a first optical device to the first mounting block;
attaching a second optical device to the second mounting block; and
substantially aligning an optical axis of the first optical device with an optical axis of the second optical device with the adjustment means.

16. The method of claim 15 further comprising adjusting the distance between the first optical axis and the second optical axis by adjusting the distance between the first mounting block and the second mounting block.

17. The method of claim 16 wherein the distance between the first mounting block and the second mounting block is adjusted by rotating a threaded member which is received in a threaded socket associated with one of the first mounting block and the second mounting block.

18. The method of claim 17 wherein the alignment of the first optical axis with respect to the second optical axis is maintained during adjustment of the distance between the first mounting block and the second mounting block by at least one guide operatively associated with both first mounting block and the second mounting block.

19. The method of claim 15 wherein the step of substantially aligning an optical axis of the first optical device with an optical axis of the second optical device comprises:
articulating a first hinge operatively associated with the first mounting block causing adjustment of the first optical axis in a first adjustment plane; and
articulating a second hinge operatively associated with the second mounting block causing adjustment of the second alignment axis in a second adjustment plane.

20. The method of claim 19 wherein the first hinge comprises a slot defined by the first mounting block and the second hinge comprises a slot defined by the second mounting block.
